(19) United States
(12) Patent Application Publication
(10) Pub. No.: US 2005/0104714 A1
(43) Pub. Date: May 19, 2005

(54) Locking mechanism

(76) Inventors: Glen William Wallis, Burton-On-Trent (GB); Rob Todd, Newcastle Upon Tyne (GB)

Correspondence Address: MICHAEL BEST & FRIEDRICH, LLP, 100 E WISCONSIN AVENUE, MILWAUKEE, WI, 53202, US

(21) Appl. No.: 10/501,390

(22) PCT Filed: Jan. 13, 2003
(86) PCT No.: PCT/GB03/00080

(30) Foreign Application Priority Data
Jan. 14, 2002 (GB) 0200691.4

(51) Int. Cl. E05B 47/00

(52) U.S. Cl. 340/5.64; 340/545.1

(57) ABSTRACT

A locking mechanism is provided which is operable to restrict unauthorised access to a structure such as a house, the locking mechanism being operable to permit external access, by means of at least one remote control device (14) operable from outside the structure, the locking mechanism being arranged to cooperate with at least one internal safety device (17), for example the smoke detector or fire alarm, the locking mechanism being such that if the safety device (17) is activated, this unlocks the locking mechanism to facilitate escape from the structure.

The invention relates to locking mechanisms and particularly to electronic locking mechanisms for use with structures such as buildings.

More and more sophisticated locking mechanisms are becoming available, for example to secure structural building such as a house, with a view to providing a high degree of security, including security against unauthorised entry. However, a down side of the increased security is that if some problem should arise with the householder within the house, for example because of a fire, the householder can actually be put at an increased risk because of increased difficulty in escaping from the house.

The invention seeks to provide a locking mechanism which can provide a high degree of security, but facilitates escape in the event of an emergency such as a fire.

Accordingly, the invention provides a locking mechanism operable to restrict unauthorised access to a structure such as a house, the locking mechanism being operable to permit external access, by means of at least one remote control device operable from outside the structure, the locking mechanism being arranged to cooperate with at least one internal safety device, for example a smoke detector or fire alarm, the locking mechanism being such that if the safety device is activated, this unlocks the locking mechanism to facilitate escape from the structure.

The locking mechanism may be such that if the safety device is activated, to facilitate escape from the structure, access from outside the structure is still prevented, except by use of an authorised remote control device.

Preferably, activation of the safety device unlocks more than one locking mechanism so that more than one escape route is provided, for example through at least one door and/or at least one window.

The invention includes a structure fitted with a locking mechanism according to the invention.

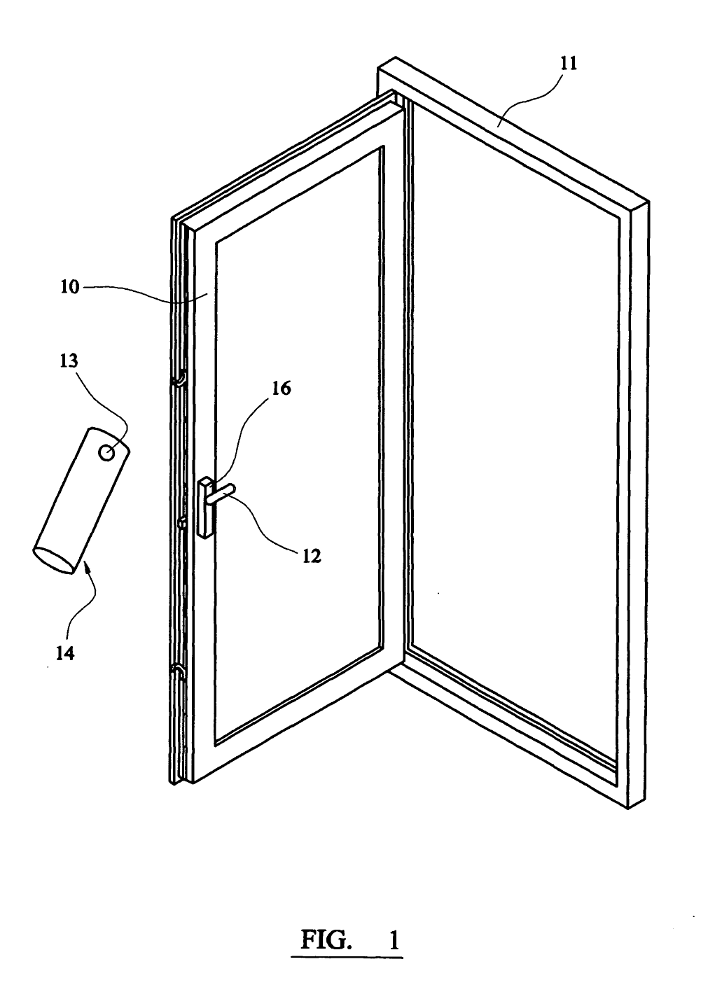

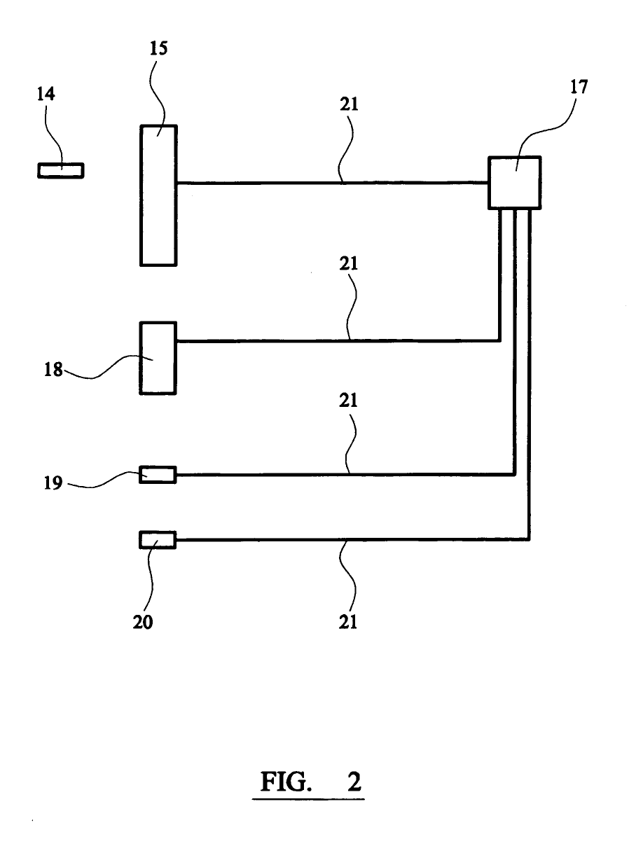

By way of example a specific embodiment of the invention will now be described, with reference to FIGS. 1 and 2 of the accompanying drawings.

FIG. 1 is a diagrammatic illustration of a door fitted with an embodiment of locking mechanism according to the invention; and

FIG. 2 is a diagrammatic view of a control system for the locking mechanism.

FIG. 1 illustrates an external house door 10 hinged to a frame 11. An internal handle 12 is visible in FIG. 1 and there is a similar external handle which is not visible in the drawings.

The door can be locked in the closed position in any desired manner and can be unlocked from outside the house by pressing a button 13 on a fob 14 shown in FIG. 1 to an enlarged scale.

During normal operation of the door, only the fob 14 is required. However, referring to FIG. 2, the electrical components of the door locking mechanism 16 is associated with at least one internal safety device 17. This may for example be a smoke detector or fire alarm.

The house has other locking mechanisms, including, for example, a rear door locking mechanism 18 and two window locking mechanisms 19 and 20. The locking mechanisms 18, 19 and 20 are also connected to the safety device 17.

The connections may be by hard wiring 21 or the devices may communicate remotely, for example using radio signals.

In the event that there is a fire within the house, then even if the locking s mechanisms are locked from the outside and the inside, activation of the device 17 causes all the locking mechanisms to be unlocked from the inside. This enables any occupants of the house to rapidly escape from the house by any door or window.

The locking mechanisms remain locked from the outside, so unauthorised access is still not possible. Authorised access from outside can be obtained by using the fob 14 or any other fob in the possession of an authorised person.

Although the invention may be used with any desired locking mechanism, a particularly convenient locking mechanism is that described in our co-pending international patent application claiming priority from application number GB0200677.3

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A locking mechanism operable to restrict unauthorised access to a structure such as a house, the locking mechanism being operable to permit external access, by means of at least one remote control device operable from outside the structure, the locking mechanism being arranged to cooperate with at least one internal safety device, for example a smoke detector or fire alarm, the locking mechanism being such that if the safety device is activated, this unlocks the locking mechanism to facilitate escape from the structure.

2. A locking mechanism as claimed in claim 1, such that if the safety device is activated, to facilitate escape from the structure, access from outside the structure is still prevented, except by use of an authorised remote control device.

3. A locking mechanism as claimed in claim 1, in which activation of the safety device unlocks more than one locking mechanism so that more than one escape route is provided, for example through at least one door and/or at least one window.

4. A locking mechanism as claimed in claim 1, in which the remote control device comprises a fob.

5. A structure fitted with a locking mechanism operable to restrict unauthorised access to a structure such as a house the locking mechanism being operable to permit external access by means of at least one remote control device operable from outside the structure, the locking mechanism being arranged to cooperate with at least one internal safety device, for example a smoke detector or fire alarm, the locking mechanism being such that if the safety device is activated, this unlocks the locking mechanism to facilitate escape from the structure.

6. A locking mechanism as claimed in claim 2, in which activation of the safety device unlocks more than one locking mechanism so that more than one escape route is provided, for example through at least one door and/or at least one window.
